(19) United States
(12) Patent Application Publication
(10) Pub. No.: US 2020/0128148 A1
(43) Pub. Date: Apr. 23, 2020

(54) DOCUMENT READING DEVICE AND IMAGE FORMING APPARATUS INCLUDING SAME

(71) Applicant: SHARP KABUSHIKI KAISHA, Osaka (JP)

(72) Inventors: SHOHICHI FUKUTOME, Osaka (JP); KENJI NAKANISHI, Osaka (JP); YASUHIRO SUTOH, Osaka (JP); HISASHI YAMANAKA, Osaka (JP); TOSHIKI FUKUNISHI, Osaka (JP)

(21) Appl. No.: 16/601,063

(22) Filed: Oct. 14, 2019

(30) Foreign Application Priority Data
Oct. 17, 2018 (JP) 2018-195949

(51) Int. Cl. H04N 1/40; H04N 1/60; H04N 1/00

(52) U.S. Cl. CPC H04N 1/40012; H04N 1/40087; H04N 1/00806; H04N 1/6063

(57) ABSTRACT

A document reading device includes red, green, and blue photoelectric transducers; a reader that reads a color image of a document with the photoelectric transducers; and a converter that converts the read color image into a grayscale image. The converter determines the maximum tone value MAX(RGB) among the red, green, and blue tone values of the RGB signal (RGB) of the pixel of the red, green, and blue colors to be a grayscale value of the pixel.

### BACKGROUND OF THE INVENTION

### Field of the Invention

The present invention relates to a document reading device and an image forming apparatus including the document reading device, particularly a document reading device and an image forming apparatus that forms a color image by scanning a document and converts the color image into a grayscale image.

### Description of the Background Art

A typical document reading device has a mode for scanning a document and forming a color image of the document, and a mode for scanning a document forming a grayscale image by converting the color image of the document.

A typical process of converting a color image of a document into a grayscale image includes scanning a document using photoelectric transducers of red, green, and blue colors, forming a color image of the document, representing each pixel in the color image by a combination of red, green, and blue tone values, weighting each of the tone values of the three colors, calculating a mixed value by adding the weighted tone values of the three colors, and selecting the mixed value as a grayscale value.

If dust or dirt resides between the photoelectric transducers and a target document when the document is scanned using the photoelectric transducers, one of the three color tone values of a pixel acquired by the photoelectric transducers will be an erroneous value that does not represent the actual tone value of the corresponding color. As a result, a color pixel not matching the actual color appears, thereby causing image degradation.

Thus, in the past, for example, as in the technique disclosed in Japanese Unexamined Patent Application Publication No. 10-233925, an erroneous pixel not representing actual tone values was corrected by interpolating the tone values of the erroneous pixel with tone values of normal pixels surrounding the erroneous pixel.

In the technique disclosed in Japanese Unexamined Patent Application Publication No. 10-233925, the tone values of an erroneous pixel are interpolated with tone values of normal pixels surrounding the erroneous pixel. In the case where consecutive erroneous pixels appear in the form of a black streak in the image of the target document, the erroneous pixels are surrounded by an insufficient number of normal pixels. Thus, the erroneous pixels are not fully interpolated with the tone values of the normal pixels, and the black streak cannot be satisfactorily lightened.

An object of at least an embodiment of the present invention, which has been conceived in light of the issues described above, is to provide a document reading device that is able to lighten a black streak in an image even when a color image formed by scanning a document using photoelectric transducers is converted into a grayscale image.

To achieve the object described above, a document reading device includes a reader that includes red, green, and blue photoelectric transducers, the reader reading a color image of a document with the photoelectric transducers; a converter that converts the read color image into a grayscale image, the converter selecting a maximum tone value among red, green, and blue tone values of a pixel as a grayscale value of the pixel.

### SUMMARY OF THE INVENTION

A document reading device according to the present invention can effectively lighten a black streak formed in an image as a result of dust, dirt, or the like residing between a target document and photoelectric transducers, and acquire a grayscale image satisfactorily corresponding to the image of the document.

### BRIEF DESCRIPTION OF THE DRAWINGS

FIG. 1 is a schematic side view of an image forming apparatus including a document reading device according to a first embodiment;

FIG. 2 is a schematic longitudinal cross-sectional view of the document reading device illustrated in FIG. 1;

FIG. 3 is a schematic block diagram illustrating a control system that comprehensively controls the image forming apparatus;

FIG. 4 is a block diagram illustrating the internal configuration of an image processor of the control system;

FIG. 5 illustrate an operational state of a black generator of the image processor;

FIG. 6 illustrates gamma correction by a second gamma corrector of the image processor;

FIG. 7 is a block diagram illustrating the internal configuration of an image processor of a document reading device according to a second embodiment;

FIG. 8 illustrates an operational state of a black generator of the image processor of the document reading device according to the second embodiment;

FIG. 9 is a block diagram illustrating the internal configuration of an image processor of a document reading device according to a third embodiment;

FIG. 10 illustrate an operational state of a density determiner of the image processor according to the third embodiment;

FIG. 11 illustrate an operational state of a black generator of the image processor according to the third embodiment; and

FIGS. 12A and 12B illustrate the advantageous effect the first embodiment, in which FIG. 12A illustrates lightening of a black streak in a typical example, and FIG. 12B illustrates lightening of a black streak in the first embodiment.

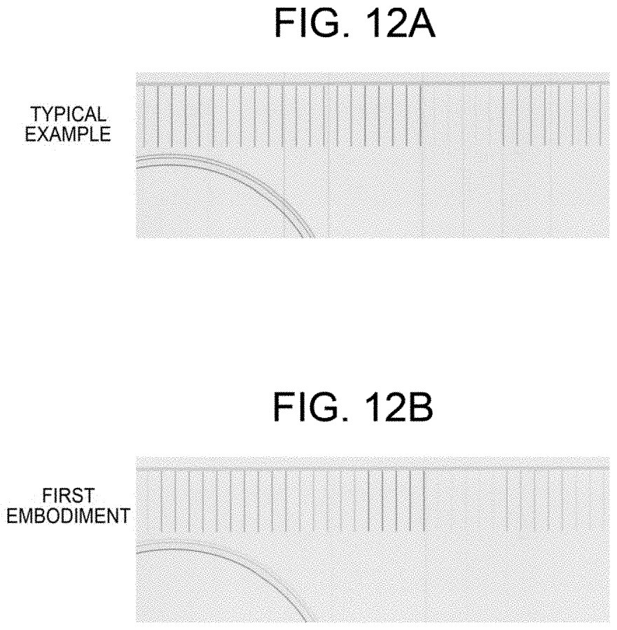

### DESCRIPTION OF THE PREFERRED EMBODIMENTS

Embodiments of the present invention will now be described with reference to the accompanying drawings.

### First Embodiment

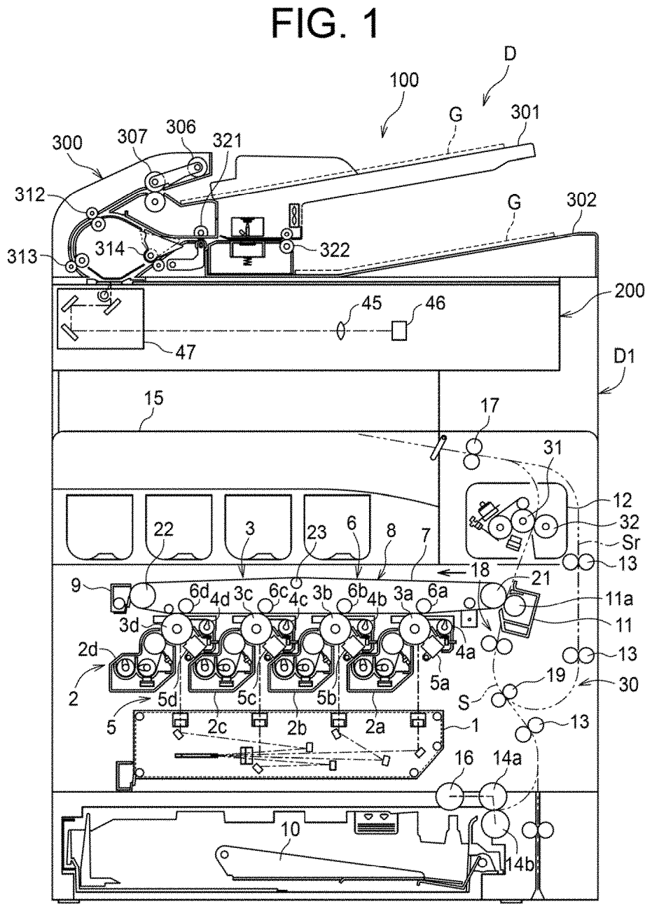

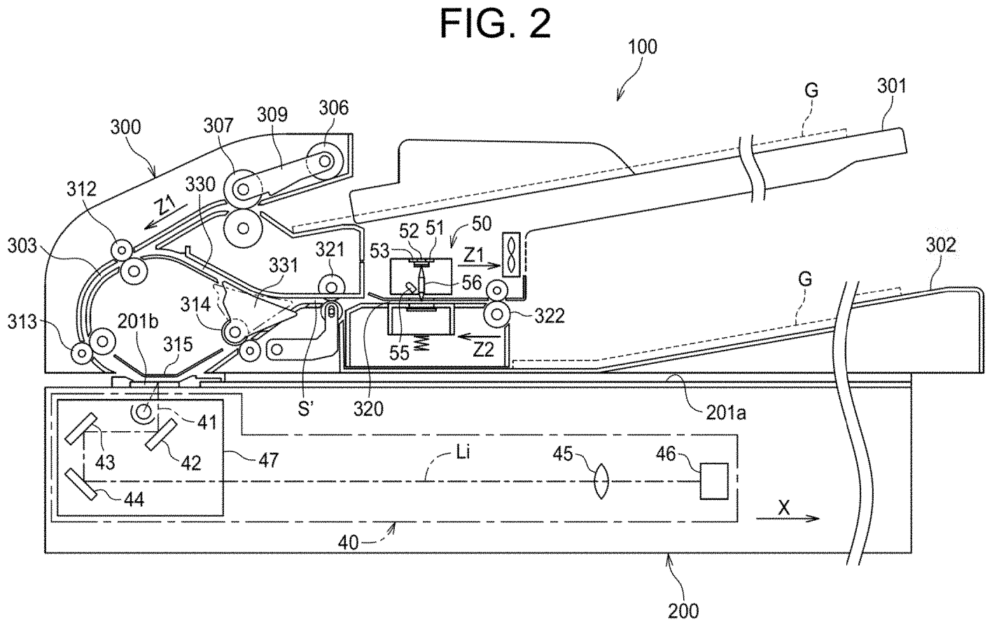

FIG. 1 is a schematic side view of an image forming apparatus D including an image reading device 100 according to a first embodiment. FIG. 2 is a schematic longitudinal cross-sectional view of the image reading device 100.

The image forming apparatus D illustrated in FIG. 1 includes an image reading device 100 that scans a target document and forms an image of the target document, and an apparatus body (image former) D1 that prints the image of the target document acquired by the image reading device 100 in multicolor or mono-color on a recording sheet, such as plain paper.

### Overall Configuration of Image Forming Apparatus

The image data processed by the apparatus body D1 of the image forming apparatus D corresponds to a color image in the colors black (K), cyan (C), magenta (M), and yellow (Y) or a monochrome image in a single color (for example, black). Hence, the apparatus body D1 of the image forming apparatus D includes four image stations to form four images in black, cyan, magenta, and yellow. The image stations for the respective colors each includes a developing unit 2, a photosensitive drum 3, a cleaner 4, a charger 5, and an intermediate transfer roller 6. The last characters “a” to “d” of the reference signs respectively correspond to the image stations for black, cyan, magenta, and yellow. In the descriptions below, the last characters “a” to “d” are omitted.

The photosensitive drums 3 are disposed at the substantial center of the apparatus body D1 in the vertical direction. The chargers 5 uniformly charge the surfaces of the corresponding photosensitive drums 3 to a predetermined potential.

An exposure unit 1 is a laser scanning unit (LSU) including a laser diode and reflective mirrors. The exposure unit 1 exposes the surfaces of the charged photosensitive drums 3 in accordance with image data, and forms electrostatic latent images corresponding to the image data on the surfaces of the photosensitive drums 3.

The developing units 2 develop the electrostatic latent images formed on the photosensitive drums 3 with K, C, M, and Y color toners. The cleaners 4 remove and collect the toners remaining on the surfaces of the photosensitive drums 3 after development and image transfer.

An intermediate-transfer-belt unit 8 is disposed above the photosensitive drums 3, and includes intermediate transfer rollers 6, an intermediate transfer belt 7, an intermediate-transfer-belt driving roller 21, a driven roller 22, a tension roller 23, and an intermediate-transfer-belt cleaner 9. The intermediate-transfer-belt unit 8 supports the intermediate transfer belt 7 in an extended state, and continuously moves the intermediate transfer belt 7 in a predetermined sheet transport direction (the direction indicated by an arrow in the drawing). The intermediate transfer belt 7 is disposed in contact with the photosensitive drums 3. Toner images on the surfaces of the photosensitive drums 3 are sequentially transferred and overlaid onto each other on the intermediate transfer belt 7, to form a color tone image (toner images of the respective colors). The overlaid toner images are transported together with the intermediate transfer belt 7 and are transferred onto a recording sheet at a secondary transfer device 11 including a transfer roller 11a.

The intermediate-transfer-belt cleaner 9 includes a cleaning blade in contact with the intermediate transfer belt 7, and removes and collects residual toners.

A feeder tray 10 stores recording sheets. An output tray 15 stores printed recording sheets in a face-down state.

The apparatus body D1 includes a sheet transporter 30 that transports a recording sheets from the feeder tray 10 to the output tray 15 through the secondary transfer device 11, a fixing device 12, etc. The sheet transporter 30 includes an S-shaped sheet path S. A pickup roller 16 feeds each recording sheet in the feeder tray 10 to the sheet path S. Each sheet is transported through a sorting roller 14a and a separating roller 14b, two transport rollers 13, two pre-registration roller 19, and two registration rollers 18, in tins order.

The fixing device 12 receives the recording sheet on which the toner images are transferred. While the recording sheet is transported between a heating roller 31 and a pressing roller 32, the color toner images on the recording sheet are thermally fixed. The recording sheet is then output into the output tray 15 by the output rollers 17.

A monochrome image may be formed using one of the four image forming stations and then transferred onto the intermediate transfer belt 7 of the intermediate-transfer-belt unit 8. The monochrome image is transferred from the intermediate transfer belt 7 onto a recording sheet, and fixed to the recording sheet, like a color image.

In the case where images are to be formed on both sides of a recording sheet, i.e., the front and back faces of the recording sheet, the apparatus body D1 fixes an image on the front face of the recording sheet, reverses the rotation of the output rollers 17 to send the recording sheet to the reverse path Sr and flip over the recording sheet, sends back the recording sheet to the registration rollers 18, prints and fixes an image of the back face of the recording sheet, and outputs the recording sheet into the output tray 15.

### Overall Configuration of Image Reader

FIG. 2 is a schematic longitudinal cross-sectional view of the image reading device 100 illustrated in FIG. 1.

The image reading device 100 illustrated in FIGS. 1 and 2 operates in a document fixed mode in which an image on a target document is scanned while the target document is being fixed in place, or a document transport mode in which an image on a target document is scanned while the document is being transported.

The image reading device 100 includes a document scanner 200 and an automatic document feeder (ADF) 300. The document scanner 200 includes a first image scanner 40 that scans an image on one face (front face) of a transported target document G, and a second image scanner 50 that scans an image on the other face (back face) of the document G.

In the first image scanner 40, light is emitted from the light source 41, such as a light-emitting diode (LED), to the front face or target face of the document G placed on a platen glass 201a or a document reader glass 201b. The light reflected at the target face of the document G is farther reflected at three reflecting mirrors 42, 43, and 44 such that the optical path Li of the reflected light extends in a direction parallel to the platen glass 201a and the document reader glass 201b. The light then enters an imaging lens 45. The imaging lens 45 forms an image of the incident light on the red (R), green (G), and blue (B) photoelectric transducers (for example, charge-coupled devices (CCDs)) 46. The red, green, and blue CCDs 46 respectively constitute red, green, and blue line image sensors. The red, green, and blue line image sensors respectively include red, green, and blue CCD arrays extending in a main scanning direction (perpendicular to plane of FIG. 2). The red, green, and blue line image sensors are disposed in this order along a sub-scanning direction X at single line intervals. The red, green, and blue CCDs 46 convert light reflected at the imaging lens 45, i.e., document image light, into electrical signals. The light source 41 and the three reflecting mirrors 42 to 44 are disposed in a scanning unit 47.

The second image scanner 50 includes a light source 55, such as an LED, that emits light to the back face of the document, and a color contact image sensor (CIS) unit that forms images of the light reflected at the back face of the document at red (R), green (G), and blue (B) line image sensors 51, 52, and 53 using, for example, a Selfoc (trademark) lens array 56, which is a gradient index lens array. The red, green, and blue line image sensors 51 to 53 respectively include red, green, and blue CCDs arrayed along the main scanning direction of the target document G, as the CCDs 46. The red, green, and blue line image sensors 51 to 53 are disposed in this order along the sub-scanning direction X at single line intervals.

The image reading device 100 includes a fixed-document reading mechanism and a transported-document reading mechanism (both not illustrated). The fixed-document reading mechanism shifts the scanning unit 47 of the first image scanner 40 in the sub-scanning direction (in the direction of arrow X in the drawing) and reads the light reflected at the target document, i.e., scans the image of the document. The transported-document reading mechanism illuminates a document transported over document reader glass 201b in the transport direction Z1 by the ADF 300 with light passing through the document reader glass 201b from the light source 41 disposed at a predetermined position (below the document reader glass 201b) in the document scanner 200, and reads the reflected light from the document, i.e., reads the image of the document.

In the first image scanner 40, only the scanning unit 47 is shiftable in the sub-scanning direction, and the imaging lens 45 and the red, green, and blue CCDs 46 are fixed at predetermined positions below the platen glass 201a. Alternatively, a carriage that transports the imaging lens 45 and the red, green, and blue CCDs 46 in the sub-scanning direction may be provided. Alternatively, a CIS unit may be placed in the carriage, in place of the imaging lens 45, the red, green, and blue CCDs 46, and the scanning unit 47.

The second image scanner 50 is disposed in a switchback path 320 described below. The second image scanner 50 emits light from the light source 55 to the back face of a document transported through the switchback path 320, forms images of the reflected light at the red, green, and blue line image sensors 51 to 53 using the Selfoc lens array 56, and reads the color image information.

The platen glass 201a includes a transparent glass plate. The ADF 300) is pivotably supported (for example, by a hinge) about an axis extending in the transport direction Z1 of a target document so as to be opened relative to the document scanner 200. The lower face of the ADF 300 serves as a document holder that holds, from above, the document placed on the platen glass 201a of the document scanner 200.

The ADF 300 includes a document tray 301 on which documents G are placed, and an output tray 302 disposed below the document tray 301.

Near the left edge of the document tray 301 in the drawing, an endless belt 309 is wound around a pickup roller 306 and an upper separating roller 307. The pickup roller 306 rotates in the clockwise direction in the drawing and feeds each document G in the document tray 301 to a first path 303 in the transport direction Z1.

In the first path 303, two registration rollers 312, two pre-reading rollers 313, the document reader glass 201b, and two post-reading rollers 314 are disposed in tins order from the upstream side. A reading guide 315 is disposed above and facing the document reader glass 201b.

An image on a face of a document G is scanned by the first image scanner 40 through the document reader glass 201b. The document G is then fed to the switchback path 320 extending horizontally in the downstream region of the post-reading rollers 314, transported in the transport direction Z1 by a forward rotation (counterclockwise rotation in the drawing) of two reverse rollers 321 disposed at one end of the switchback path 320 (the end adjacent to the post-reading rollers 314), outputted into the output tray 302 by output rollers 322 disposed at the other end of the switchback path 320.

The second image scanner 50 is disposed above the switchback path 320 and scans the back face of the document G. A second path 330 is disposed at the end of the switchback path 320 adjacent to the post-reading rollers 314, and branches from the first path 303 from downstream of the post-reading rollers 314. After the back face of the document G is scanned, the document G is transported from the switchback path 320 to the second path 330 in the transport direction Z2 as a result of the reverse rollers 321 rotating in the forward direction. The second path 330 guides the document G upstream of the registration rollers 312 in the first path 303.

A reverse gate 331 is disposed at the branching portion S′ to guide the document G to the second path 330 after scanning of the back face of the document G. The reverse gate 331 is supported by the rotary axis of the upper post-reading roller 314 so as to freely swing. Usually, the reverse gate 331 is disposed at a first position indicated by the solid line in the drawing due to its own weight and connects the switchback path 320 and the second path 330. When the document G is transported from the first path 303 over the document reader glass 201b, the reverse gate 331 is pushed by the front edge of the document G and swings in a counterclockwise direction in the drawing to a second position indicated by the dashed line in the drawing and connects the first path 303 to the switchback path 320.

When the image reading device 100 enters the document fixed mode for scanning the document G, the light source 41 emits light to the document G placed on the platen glass 201a through the platen glass 201a while shifting in the sub-scanning direction X at a constant rate, to scan the document G.

In contrast, when the image reading device 100 enters the document transport mode for scanning the document G, the scanning unit 47 stays at the predetermined position illustrated in FIG. 2 while the document G is transported to the document reader glass 201b through the first path 303 by the ADF 300. The document G is then transported through the switchback path 320 and outputted into the output tray 302. While the document G is transported, the surface of the document G is irradiated with the light from the light source 41 through the document reader glass 201b.

In either the document fixed mode or the document transport mode, the light reflected at the document G is farther reflected at the three reflecting mirrors 42, 43, and 44 such that the optical path Li of the reflected light extends in a direction parallel to the platen glass 201a and the document reader glass 201b. The imaging lens 45 receives the light and forms images on the CCDs 46. The red, green, and blue CCDs 46 convert the light reflected at the imaging lens 45 or the image light of the document G to analog electrical signals (analog color image data).

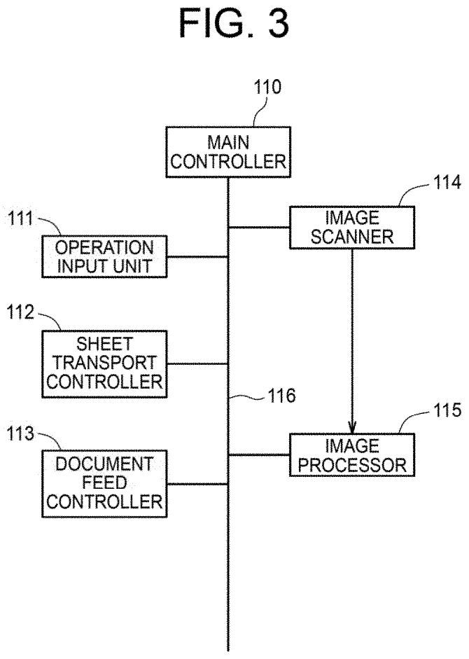

FIG. 3 is a schematic block diagram of a control system that comprehensively controls the image forming apparatus D. The image forming apparatus D includes a main controller 110 that comprehensively controls the apparatus, an operation input unit 111, a sheet transport controller 112, a document feed controller 113, an image scanner 114, and an image processor 115. These components are connected with each other via a communication bus 116.

The operation input unit 111 processes a signal from a touch-panel type operation panel (not illustrated) disposed on the upper front face of the apparatus body D1, and instructs the formation of a color image or a grayscale image corresponding to the color image of the document G on a recording sheet. The sheet transport controller 112 controls the sheet transporter 30 that transports a recording sheet picked up at the feeder tray 10 along a sheet path S to the output tray 15. The document feed controller 113 controls the ADF 300 that transports the document G placed on the document tray 301 to the output tray 302.

The image scanner 114 includes the first and second image scanners 40 and 50, and outputs color image data read by the scanners 40 and 50 to the image processor 115. The image processor 115 performs various types of signal processing, such as AD conversion, (described below) on the received color image data, and converts the received color image data into grayscale image data. The processed image data is sent to the main controller 110. The main controller 110 sends an instruction to the sheet transport controller 112 to transport the recording sheet through a sheet path S. The main controller 110 also controls the apparatus body D1 to form an image corresponding to the color image data or the grayscale image data on the transported recording sheet. Note that only black toner is used when forming a grayscale image on the recording sheet.

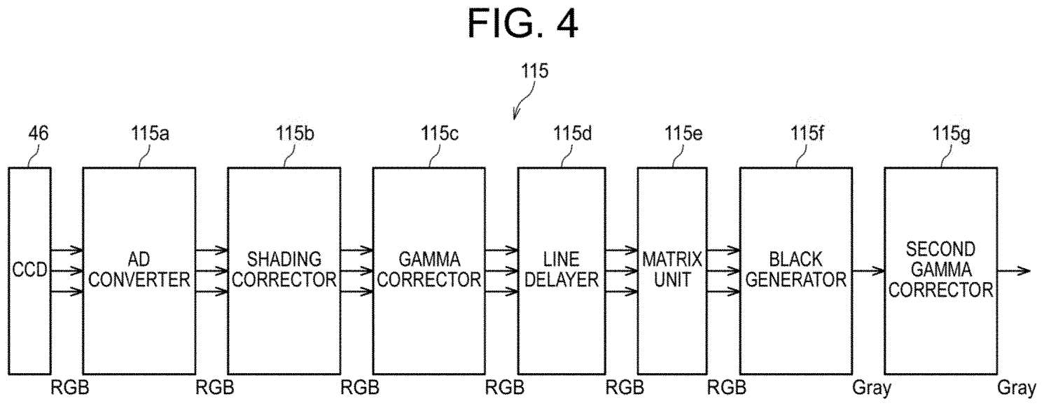

FIG. 4 is a block diagram illustrating the internal configuration of the image processor 115. The main controller 110 controls the ADF 300 and transports a document G placed on the document tray 301 to the document reader glass 201b. While the document G is being transported, the first image scanner 40 scans the document G and forms a color image. The color image is converted into a grayscale image. The conversion is described below.

The image processor 115 illustrated in FIG. 4 includes an AD converter 115a that converts the red, green, and blue analog signals respectively from the red, green, and blue CCDs 46 to digital signals. A shading corrector 115b processes the image data corresponding to the red, green, and blue digital signals (hereinafter referred to as “RGB signal”) from the AD converter 115a to remove various distortions in the illumination system, the imaging system, and the image-pickup system of the image reading device 100. A gamma corrector 115c performs gamma (γ) correction on the RGB signals that so as to achieve natural colors in the image of the document G printed on the recording sheet. The line delayer 115d delays the R, G, and the B values of the RGB signal so that the line positions in the data of the R, G, and the B values of the RGB signal coincide with each other, because the line positions of the red, green, and blue CCDs 46 differ from each other. A matrix unit 115e corrects the ROB signal so as to suppress a variation in color (color difference) between the image reading device 100 and other similar image readers. A black generator 115f converts the RGB signal output from the matrix unit 115e into a grayscale signal.

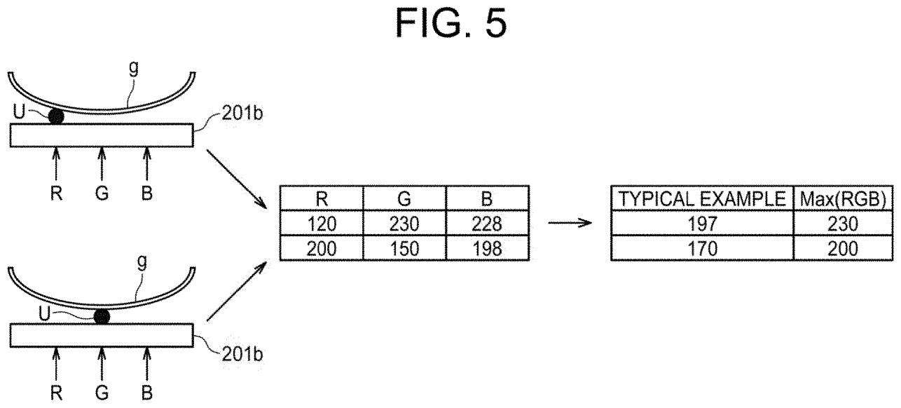

Conversion of an RGB signal to a grayscale signal by the black generator (converter) 115f will now he described with reference to FIG. 5. FIG. 5 illustrates RGB signals from the matrix unit 115e corresponding to two pixels. For simplicity of display, the red, green, and blue colors are each represented by a value corresponding to 256 shades.

FIG. 5 illustrates an example in which a region g of the document 0 disposed in the vicinity of the target pixel to be converted is white and a dust particle U is black. In FIG. 5, the top pixel exemplifies a case in which the dust particle U resides at a position corresponding to the red CCD. The RGB signal of the pixel has tone values (R,G,B)=(120,230,228). The red tone value R(120) is smaller than the green tone value G(230) and the blue tone value B(228) due to the black dust particle U. The top pixel exemplifies a case in which the dust particle U resides at a position corresponding to the green CCD. The RGB signal (200,150,198) has a green tone value G(150) that is smaller than the red tone value R(200) and the blue tone value B(198) due to the black dust particle U. The black generator 115f uses the maximum tone value MAX(RGB) among the red, green, and blue tone values of the pixel as a grayscale value, as illustrated in FIG. 5. For the top pixel, the green tone value G(230) is selected as the grayscale value. For the bottom pixel, the red tone value R(200) is selected as be the grayscale value.

For comparison, FIG. 5 illustrates typical examples of grayscale values each obtained by respectively weighting the red, green, and blue tone values of the RGB signal (R,G,B) of the pixel with coefficients (0.3, 0.6, 0.1).

In this embodiment, the maximum tone value MAX(RGB) among the red, green, and blue tone values of the RGB signal (R,G,B) is selected as the grayscale value, to convert the RGB signal into a grayscale signal. The maximum tone value MAX(RGB) (G(230) for the top pixel and R(200) for the bottom pixel) is a tone value that is unaffected by the dust particle U and corresponds to a color having lowest density (near-white and bright). A typical grayscale value (the value (197) for the top pixel and the value (170) for the bottom pixel) is a small tone value that is affected by the black dust particle U because the value is acquired by weighting the corresponding color value with a coefficient corresponding to the color value. That is, the maximum tone value MAX(RGB) (=grayscale value) has a tone value larger than the typical grayscale value (the value (197) for the top pixel and the value (170) for the bottom pixel) and corresponding to a color having a low density (near-white and bright). Consecutive pixels in the typical example are converted into grayscale values of high density (near-black and dark) due to the black dust particle U. Such grayscale values are likely to cause a black streak to appear. In this embodiment, the maximum tone values MAX(RGB) that are not affected by the black dust particle U are selected as the grayscale values. The grayscale values correspond to a near-white light color having a low density. Thus, in this embodiment, the density of the black streak can be decreased (the black streak can be lightened) compared with the typical example.

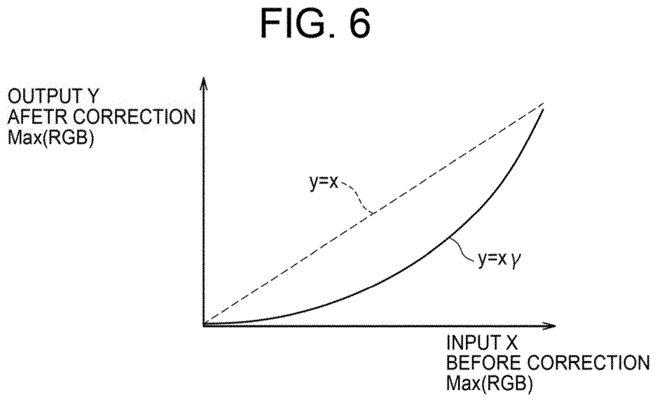

As illustrated in FIG. 4, the grayscale values converted by the black generator 115f are input to a second gamma corrector 115g. The second gamma corrector 115g corrects an input x (the maximum tone value MAX(RGB) before correction) so as to obtain a function y=x^{Y} represented by the solid line in FIG. 6, where input x is the maximum tone value MAX(RGB) acquired by the black generator 115f, and output y is the maximum tone value MAX(RGB) after correction.

That is, the black generator 115f converts the maximum tone values MAX(RGB) of the RGB signal of every pixel in the image formed by scanning the document G into a grayscale value. Thus, if the maximum tone values MAX(RGB) are input as “x” and directly outputted as “y” (function y=x indicated by the dashed line), the entire image formed on the recording sheet will have a low density (will be bright). Thus, the second gamma corrector 115g corrects the maximum tone values MAX(RGB) into smaller values so that the density of the image formed on a recording sheet has a natural appearance. As illustrated in FIG. 6, the gamma value γ for gamma correction is a value that causes the output y (the input x (the maximum tone value MAX(RGB) after correction) to be smaller than the input x (the maximum tone value MAX(RGB) before correction). The gamma value γ is determined by repeatedly forming trial prints so as to obtain an image formed on the recording sheet that has a density that appears natural. The maximum tone value MAX(RGB) is corrected into a small value in accordance with the function y=x^{Y} (a predetermined rule). Note that alternate to correcting the tone value MAX(RGB) before correction into the tone value MAX(RGB) after correction through calculation based on the function, the function y=x^{Y} may be preliminarily provided in the form of a one-dimensional lookup table (1DLUT), and the tone value MAX(RGB) after correction may be retrieved from the lookup table.

The corrected maximum tone value MAX(RGB) for every pixel corrected by the gamma corrector 115g is output to the main controller 110, and a grayscale image corresponding to the maximum tone values MAX(RGB) (the grayscale values) after correction is formed on the recording sheet by the apparatus body D1.

In this embodiment, the grayscale image formed on the recording sheet by the apparatus body D1 is corrected so that the maximum tone values MAX(RGB) after gamma correction are corrected into small values having more natural tones. In this way, an image having densities that appear more natural can be formed on a recording sheet.

In this embodiment, when the color image formed by scanning the document G transported from the document tray 301 to the document reader glass 201b in the document transport mode is converted into a grayscale image, the maximum tone value MAX(RGB) among the red, green, and blue tone values of each RGB signal is selected as a grayscale value. In the document transport mode, if a dust particle U is attached to the document reader glass 201b, a black streak due to the dust particle U is likely to appear because the scanning unit 47 is fixed in a position below the document reader glass 201b. In contrast, when an image is read in a document fixed mode, black streaks are less likely to appear even when a dust particle U is attached to any position on the platen glass 201a because the scanning unit 47 is transported along the platen glass 201a. Thus, in this embodiment, black streaks can be effectively lightened when a color image formed by scanning the document G in the document transport mode is converted into a grayscale image.

### Second Embodiment

The second embodiment of the present invention will now be described.

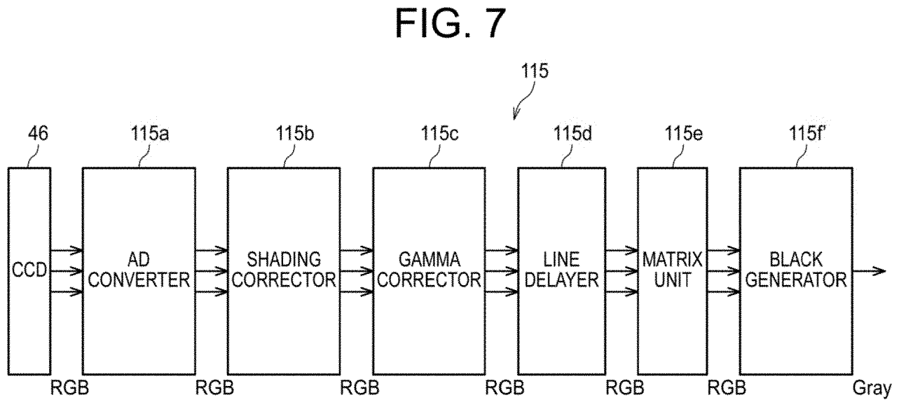

FIG. 7 is a block diagram of the internal configuration of an image processor 115 according to this embodiment. The image processor 115 illustrated in FIG. 7 includes a black generator 115f′ that has a configuration different from the black generator 115f according to the first embodiment.

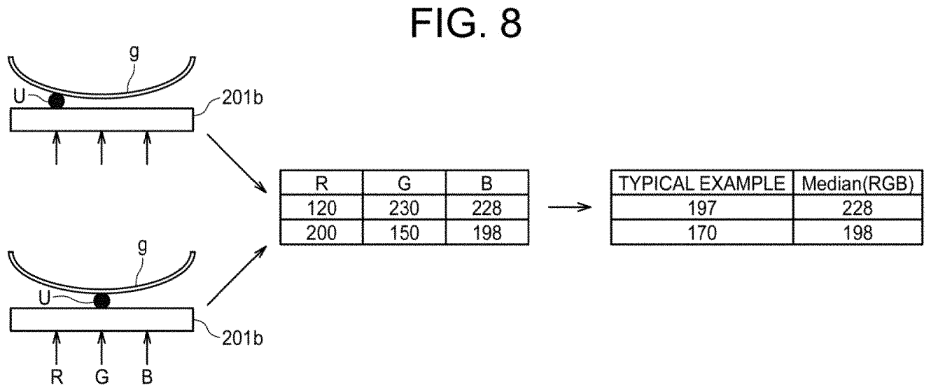

The black generator 115f according to this embodiment convert an RGB signal output from a matrix unit 115e into a grayscale signal by selecting a median tone value among the red, green, and blue tone values of the RGB signal (R,G,B) as a grayscale value, and converts the RGB signal into a grayscale signal. The operation of such conversion will now be described in detail with reference to FIG. 8.

Similar to FIG. 5 illustrating the operation of the black generator 115f according to the first embodiment, FIG. 8 illustrates a top pixel exemplifying a case in which a dust particle U resides at a position corresponding to the red CCD, and the RGB signal of the pixel has tone values (R,G,B)=(120,230,228), and a bottom pixel exemplifying a case in which a dust particle U resides at a position corresponding to the green CCD, and RGB signal of the pixel has tone values (R,G,B)=(200,150,198), a region g of the document G is white. The median tone value of the red, green, and blue tone values of a pixel is selected as a grayscale value. The median tone value Median(RGB) of the top pixels is determined to be Median(RGB)=B(228), and the bottom pixel Median(RGB)=B(198).

In this embodiment, the small tone values of the pixels affected by the black dust particle U (R(120) of the top pixel, and G(150) of the bottom pixel) are not used, and the median tone values Median(RGB) not affected by the black dust particle U (B(228) of the top pixel, and B(198) of the bottom pixel) are selected as grayscale values. Thus, the grayscale values selected for the pixels are not affected by the black dust particle U, and have tone values that are larger than those of typical grayscale values affected by the black dust particle U (the value (197) of the top pixel, and the value (170) of the bottom pixel). That is, the grayscale values correspond to low density (high brightness). This effectively suppresses the appearance of black streaks compared with the typical example.

### Third Embodiment

The third embodiment will now be described.

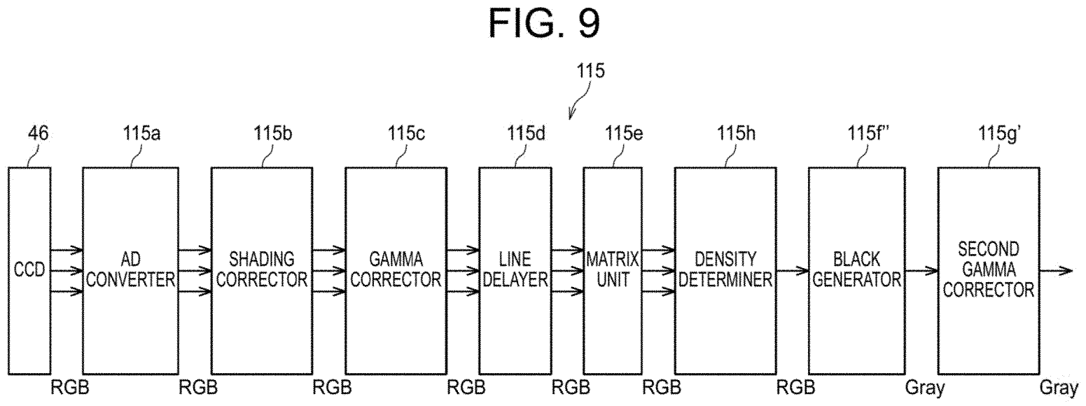

FIG. 9 is a block diagram illustrating the internal configuration of an image processor 115 according to this embodiment. The image processor 115 illustrated in FIG. 9 differs from the image processor 115 according to the first embodiment (see FIG. 4) in that a density determiner 115h is further provided, and a black generator 115f′ has a configuration different from that of the black generator 115f according to the first embodiment.

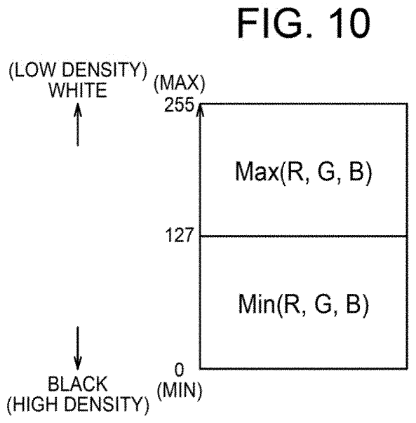

In FIG. 9, a density determiner (determiner) 115h calculates the average tone value of the red, green, and blue tone values of the RGB signals (R,G,B) for every pixel in the image formed by reading the document G, by dividing the image into small regions including a predetermined number of pixels, e.g., a 9-pixel 3 by 3 matrices, or a 25-pixel 5 by 5 matrices. As illustrated in FIG. 10, the density determiner 115h determines whether the average tone value is larger than or smatter than a predetermined value (for example, the median value 127 of the 256 shades). If the average tone value is larger than the predetermined value (the median value 127), the density determiner 115h determines that the corresponding small region of the document G has a low density on the white (lighter) side. If the average tone value is smaller than the predetermined value, the density determiner 115h determines that the corresponding small region of the document G has a high density on the black (darker) side.

If a small region of the document G is determined to have a low density on the white side, the black generator 115f″ determines the maximum tone value MAX(RGB) among the red, green, and blue tone values of the RGB signal to be the grayscale value, as in the first embodiment. The detailed operation of selecting the grayscale value is the same as that described in the first embodiment with reference to FIG. 5.

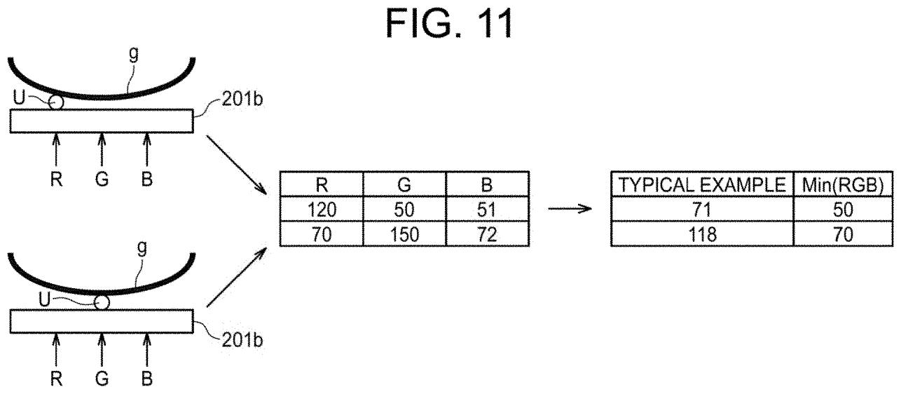

If a small region of the document G is determined to have a high density on the black side, the black generator 115f′ determines the minimum tone value Min(RGB) among the red, green, and blue tone values of the RGB signal (R,G,B) to be the grayscale value. The detailed operation of selecting the grayscale value will now be described with reference to FIG. 11.

FIG. 11 illustrates a case in which the average tone value is smaller than a predetermined value, that is, when the density is high on the black side, i.e., when a small region g of the document G around a target pixel to be converted is black and a dust particle U is white. In FIG. 11, the top pixel exemplifies a case in which the white dust particle U resides at a position corresponding to the red CCD. In the RGB signal (R,G,B)=(120,50,51) of the pixel, the red tone value R(120) is larger than the green tone value G(50) and the blue tone value B(51) due to the white dust particle U. When the white dust particle U resides at a position corresponding to the green CCD, the green tone value G (150 of the RGB signal (70,150,72) of the bottom pixel is larger than the red tone value R (70) and the blue tone value B(72). The black generator 115f′ uses the minimum tone value (Min(RGB)) among the red, green, and blue tone values of a pixel as a grayscale value. In specific, the green tone value G(50) of the top pixel is selected as a grayscale value, and the red tone value R(70) of the bottom pixel selected as a grayscale value.

Thus, in this embodiment, when the average tone value of the RGB signal of a predetermined number of pixels in a small region of the document G is larger than a predetermined value, i.e., when the color of the small region has a low density on the white side, the maximum tone value MAX(RGB) is selected as a grayscale value, as in the first embodiment. Thus, the grayscale value corresponds to a bright, near-white color having a low density, and can efficiently suppress the occurrence of black streaks in small regions on the white side.

In contrast, when the average tone value of the RGB signal of the small region is smaller than the predetermined value, i.e., when the color of the small region has a high density on the black side, the minimum tone value Min(RGB) is selected as a grayscale value. The minimum tone value Min(RGB) (G(50) of the top pixel, and R(70) of the bottom pixel in FIG. 11) is not affected by the white dust particle U, and corresponds to the darkest of the red, green, and blue colors. The grayscale value of the typical example (the example weighted with the coefficients (0.3, 0.6, 0.1) provided for comparison (the value (71) of the top pixel, and the value (118) of the bottom pixel) is a large value on the white side because it is also based on the large tone value affected by the white dust particle U (R(120) of the top pixel, and G(150) of the bottom pixel). Thus, the grayscale value of this embodiment (the minimum tone value Min(RGB)) has a high density and corresponds a color more similar to black than that of the typical example. This effectively suppresses the occurrence of white streaks in the small region g on the black side.

In FIG. 9, a second gamma corrector 115g′ is disposed downstream of the black generator 115f′. When the average tone value of the RGB signal of the small region is larger than a predetermined value, i.e., when the color of the small region has low density on the white side, the second gamma corrector 115g′ performs gamma correction to decrease the maximum tone value MAX(RGB) such that the image formed on the recording sheet has a natural appearing density, like the second gamma corrector 115g according to the first embodiment described with reference to FIG. 4.

Also, in this embodiment, the image formed on the recording sheet by the apparatus body D1 is corrected to a smaller value so that the gamma corrected maximum tone value MAX(RGB) corresponds to a natural tone in the small region having a low density on the white side. This allows a grayscale image having a natural appearing density to be formed on the recording sheet.

In this embodiment, when the average tone value of the RGB signal of the small region is smaller than a predetermined value, the minimum tone value Min(RGB) is selected as a grayscale value. If the minimum tone value Min(RGB) is an input “x” and is directly outputted as “y” to form a grayscale image on a recording sheet, the entire image formed will have a high density and will be dark. Thus, gamma correction may be performed on the minimum tone value Min(RGB) to increase to the brighter side so as to form, on the recording sheet, an image having a natural appearing density.

In the embodiments of the present invention described above, the converter selects the maximum tone value among the red, green, and blue tone values of a pixel of a color image formed by scanning a document, as the grayscale value of the corresponding pixel. Thus, if dust or dirt resides between a document, such as a white recording sheet, and photoelectric transducers, several consecutive pixels among all pixels of the color image read by the photoelectric transducers may each have red, green, and blue tone values among which one of the tone values is smaller and darker than the other two tone values, due to black dirt or the like. However, the maximum tone value between the other two tone values that are not affected by the dust or dirt is selected as the grayscale value. As a result, the consecutive pixels that appeared to be a black streak in the past are represented by low-density (bright) grayscale values. Thus, such black streaks can be lightened or eliminated.

The present invention can be implemented in various other forms without departing from the spirit or principal features of the invention. Thus, the embodiments described above are mere examples and should not be construed in a limiting sense. All modifications and variations within the equitable scope of the claims of the present invention are included in the scope of the present invention.

Since the document reading device according to at least on embodiment of the present invention can reduce the density of a black streak even when a color image of a document is read and converted into a grace tool image, the document reading device and an image forming apparatus including the document reading device. It is useful as an image forming device.

### DESCRIPTION OF REFERENCE NUMERALS

D image forming apparatus
D1 apparatus body (image former)
G document
40 first image scanner
50 second image scanner
46 charge-coupled devices (CCDs)
47 scanning unit
100 image reading device
110 main controller
114 image scanner
115 image processor
115f, 115f′ 115f″ black generator (converter)
115g, 115g′ second gamma corrector
115h density determiner
U dust particle

What is claimed is:

1. A document reading device comprising:
a reader that includes photoelectric transducers corresponding to red, green, and blue colors, the reader reading a color image of a document using the photoelectric transducers; and
a converter that converts the read color image into a grayscale image, wherein
the converter selects a maximum tone value among red, green, and blue tone values of a pixel as a grayscale value of the pixel.

2. The document reading device according to claim 1, wherein the converter corrects the grayscale value of the converted pixel to a high density side in accordance with a predetermined rule.

3. The document reading device according to claim 2, wherein the predetermined rule is a function y=x^{Y}, where x is the grayscale value of the converted pixel, y is the grayscale value after correction, and y is a value that decreases the grayscale value after correction to a value smaller than the grayscale value of the converted pixel.

4. The document reading device according to claim 1, wherein the reader reads the color image of the document transported to a predetermined position in the reader.

5. An image forming apparatus comprising:
the document reading device according to claim 1; and
an image former that forms the grayscale image of the document converted by the document reading device on a recording sheet.

6. A document reading device comprising:
a reader that includes red, green, and blue photoelectric transducers, the reader reading a color image of a document with the photoelectric transducers; and
a converter that converts the read color image into a grayscale image, wherein
the converter selects a median tone value among red, green, and blue tone values of a pixel as a grayscale value of the pixel.

7. The document reading device according to claim 6, wherein the reader reads the color image of the document transported to a predetermined position in the reader.

8. An image forming apparatus comprising:
the document reading device according to claim 6; and
an image former that forms the grayscale image of the document converted by the document reading device on a recording sheet.

9. A document reading device comprising:
a reader that includes red, green, and blue photoelectric transducers, the reader reading a color image of a document with the photoelectric transducers; and
a converter that converts the read color image into a grayscale image, wherein
the converter includes a determiner to determine a density of the document,
the converter selects a maximum tone value among red, green, and blue tone values of a pixel as a grayscale value of the pixel when a density of the document is lower than a predetermined value, and
the converter selects a minimum tone value among the red, green, and blue tone values of a pixel as the grayscale value of the pixel when the density of the document is higher than the predetermined value.

10. The document reading device according to claim 9, wherein the converter corrects the grayscale value of the pixel to a high density side in accordance with a predetermined rule, when the density of the document is low.

11. An image forming apparatus comprising:
the document reading device according to claim 9; and
an image former that forms the grayscale image of the document converted by the document reading device on a recording sheet.
